(19) United States
(12) Patent Application Publication
(10) Pub. No.: US 2026/0127214 A1
(43) Pub. Date: May 7, 2026

(54) AUTOMATIC FAX DOCUMENTS PROCESSING SYSTEM USING INTEGRATED PROGRAMMATIC AND SPECIALIZED GUIDED AND CONSTRAINED ARTIFICIAL INTELLIGENCE

(71) Applicant: Ocean Friends, Inc., Irving, TX (US)

(72) Inventors: Kushagra Mittal, Delhi (IN); Caleb Allen, Orlando, FL (US); Manish Shukla, North Bend, WA (US)

(73) Assignee: Ocean Friends, Inc., Irving, TX (US)

(21) Appl. No.: 19/381,833

(22) Filed: Nov. 6, 2025

Related U.S. Application Data
(60) Provisional application No. 63/716,727, filed on Nov. 6, 2024.

(51) Int. Cl. G06F 16/353; G06F 16/3332; G06F 40/186

(52) U.S. Cl. CPC G06F 16/353; G06F 16/3334; G06F 40/186

(57) ABSTRACT

An automatic fax document processing method is disclosed which receives one or more fax documents on an online healthcare platform from a plurality of sources, including, but not limited to, insurance companies, and one more medical service providers. The received fax documents are classified using integrated programmatic and specially guided and constrained artificial intelligence based on predefined categories, including authorization, denial, referral, payment, and miscellaneous. The relevant information from the classified fax documents is extracted using machine learning techniques and based on the extracted information an action is triggered. A final document is generated that is approved and saved by the expert user.

### CROSS-REFERENCE TO RELATED APPLICATION(S)

This application claims the benefit under 35 U.S.C. § 119(e) and 37 C.F.R. § 1.78 of U.S. Provisional Application No. 63/716,727, which is incorporated by reference in its entirety.

### FIELD OF THE INVENTION

The present invention generally relates to the field of electronics, and more specifically to an automatic fax document processing system that receives one or more fax documents in an online healthcare platform from a plurality of sources, including insurance companies, experts, and so on, to classify and extract relevant information from the fax documents.

### BACKGROUND OF THE INVENTION

Managing a large volume of documents and extracting relevant information efficiently has become a significant challenge in the modern healthcare industry. Healthcare providers deal with numerous types of documents daily, such as medical records, insurance authorizations, referrals, and billing information. Traditionally, these documents were processed manually, which was time-consuming and prone to human errors. Manual data entry and information extraction often led to delays in patient care, inefficient workflows, and difficulties in maintaining accurate records.

As healthcare systems grew and regulations became stricter, the need for a more reorganized approach to document management became increasingly essential. Healthcare providers realized that relying on outdated methods for handling documentation could result in lost or mismanaged information, ultimately affecting patient care. Furthermore, as the amount of paperwork increased, so did the operational costs associated with processing these documents. Many organizations faced challenges in keeping up with the paperwork while ensuring that they complied with all regulations and maintained high-quality care for their patients.

To address these challenges, many healthcare providers began exploring technological solutions to improve the way they handled documents. The rise of digital technologies offered new opportunities to automate and optimize various processes within healthcare systems. For instance, the start of cloud storage enabled healthcare providers to store and manage documents more effectively, allowing for easier access to critical information. However, simply digitizing documents was not enough.

### SUMMARY

An automatic fax document processing method is disclosed which receives one or more fax documents on an online healthcare platform from a plurality of sources, including, but not limited to, insurance companies, one or more experts treating a user, and so on. The received fax documents are classified based on predefined categories, including authorization, denial, referral, payment, and miscellaneous. The relevant information from the classified fax documents is extracted using machine learning techniques and based on the extracted information an action is triggered. Finally, a final document is generated that is approved and saved by an expert user such as a therapist. The therapist can make any changes in the final document, if necessary.

In an embodiment of the present disclosure, an automatic fax document processing system is disclosed which receives one or more fax documents on an online healthcare platform from a plurality of sources, including, but not limited to, insurance companies, one or more experts treating a user, and so on. The online healthcare platform is operatively coupled with a document analyzer. A classifier, integrated within the document analyzer classifies the fax documents into predefined categories, including authorization, denial, referral, payment, and miscellaneous. An extractor extracts the relevant information from the classified fax documents by using a machine learning model. An action module performs the actions based on the extracted information. Finally, a document generator generates a final document that is approved and saved by the therapist. The therapist can make any changes in the final document, if necessary.

Furthermore, in at least one embodiment, the actions include processing payments, sending notifications to parents for authorization, denial, or rejection, scheduling follow-up consultations, providing updates to insurance providers, or escalating denied claims for further review or any other relevant actions based on the extracted information.

Additionally, in at least one embodiment, the machine learning model generates a confidence score to check the accuracy level of the extracted information.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary automatic fax document processing system.

FIG. 2 depicts an exemplary automatic fax document processing process.

FIG. 3 depicts an exemplary user interface that discloses an authorization fax, including some authorizations.

FIG. 4 depicts an exemplary user interface that discloses a list of authorizations attached to the authorization fax.

FIG. 5 depicts an exemplary user interface that discloses all the fax documents received at the online healthcare platform, classified into different predefined categories.

FIG. 6 depicts an exemplary user interface that discloses the categorization of the received fax document.

FIG. 7 depicts an exemplary user interface that discloses updated user profiles based on the received fax documents.

FIG. 8 depicts an exemplary user interface that discloses a referral fax provided to the online healthcare platform by a user's pediatrician, who is referring his/her patient to another expert.

FIG. 9 depicts an exemplary network environment in which the automatic fax document processing system of FIG. 1 and the automatic fax document processing process of FIG. 2 may be practiced.

FIG. 10 depicts an exemplary computer system.

### DETAILED DESCRIPTION

An automatic fax document processing system is disclosed which receives one or more fax documents on an online healthcare platform from a plurality of sources, including, but not limited to, insurance companies, one or more experts treating a user, and so on. The online healthcare platform is operatively coupled with a document analyzer. A classifier, integrated within the document analyzer classifies the fax documents into predefined categories, including authorization, denial, referral, payment, and miscellaneous. An extractor extracts the relevant information from the classified fax documents by using a machine learning model. An action module performs the actions based on the extracted information. Finally, a document generator generates a final document that is approved and saved by the therapist. The therapist can make any changes in the final document, if necessary.

The automatic fax document processing system automates the classification and extraction of data from medical documents, significantly reducing the time and effort required for manual processing and enhancing operational efficiency. Additionally, by utilizing advanced machine learning techniques, the automatic fax document processing system improves the accuracy of data extraction, minimizing errors and ensuring reliable information retrieval. Moreover, the ability of the automatic fax document processing system to process various types of documents, including authorizations and referrals, enables healthcare providers to effectively handle diverse administrative tasks, supporting a wide range of operational needs.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Herein an AI engine is also referred to as a machine learning model. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

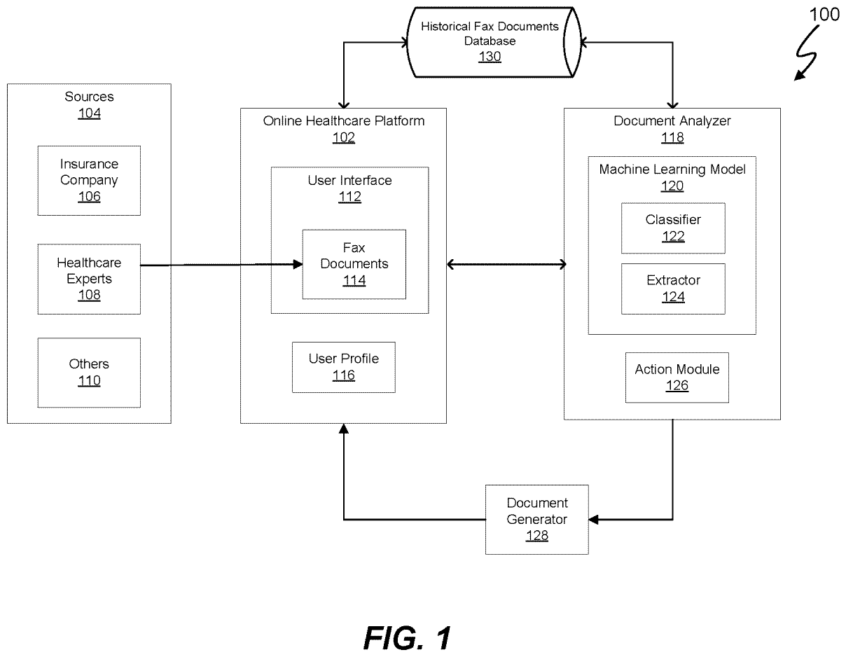

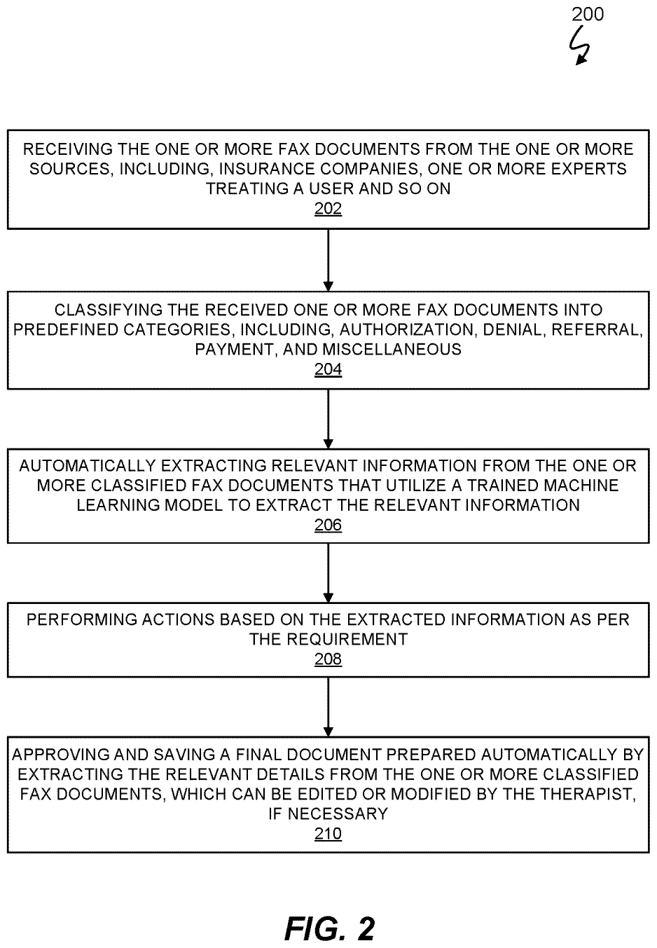

FIG. 1 depicts an exemplary automatic fax document processing system 100. FIG. 2 depicts an exemplary automatic fax document processing process 200, utilized by the automatic fax document processing system 100.

Referring to FIGS. 1 and 2, in operation 202, an online healthcare platform 102 receives one or more fax documents 114 from one or more sources 104, including, insurance companies 106, one or more healthcare experts 108 treating a user, and others 110.

An online healthcare platform 102 automatically receives and processes one or more fax documents 114 from various sources 104, including, but not limited to, insurance companies 106, healthcare experts 108 who are treating a user, and other persons or organizations 110 involved in the user's healthcare management. The online healthcare platform 102 acts as a central part where all incoming fax documents 114 from these different sources 104 are collected and managed automatically.

The online healthcare platform 102 integrates a user interface 112 within it, which allows both users and professionals to view the received fax documents 114. The term user refers to individuals such as patients who are receiving healthcare services, while professionals may include therapists, doctors, or other healthcare staff who are directly involved in the treatment or administrative processes related to the patient. These professionals are part of the respective healthcare departments and have access to the online healthcare platform 102 to manage and review fax documents 114. Fax (short for facsimile), sometimes called telecopying or telefax (short for telefacsimile), is the telephonic transmission of scanned printed material (both text and images), normally to a telephone number connected to a printer or other output device.

Moreover, access to the one or more fax documents 114 is not limited to just the patients and professionals. The online healthcare platform 102 can also grant access to other authorized individuals such as parents, guardians, or any person who has the necessary permissions to access the patient's healthcare information via the online healthcare platform 102.

In operation 204, a classifier 122 classifies the received one or more fax documents 114 into predefined categories. The predefined categories include authorization, denial, referral, payment, and miscellaneous.

The classifier 122 that is responsible for categorizing the received one or more fax documents 114 into predefined categories. These categories include authorization, denial, referral, payment, and miscellaneous. The purpose of this classification is to restructure the received fax document 114 by automatically organizing the fax documents 114 based on their content, ensuring that each fax document 114 of particular category falls under the corresponding category. For example, all the fax documents related to denial handling are stored under a folder named ‘Denial’, and all the fax documents related to referral are stored under a folder named ‘Referral’, and so on. This makes the processing part easier, as well as it becomes easier for the user accessing the online healthcare platform 102 to access the particular category of fax documents 114 all in one place. For instance, the user can directly open the ‘Denial’ folder and access all the fax documents 114 received under the corresponding category.

The classifier 122 is integrated within a document analyzer 118, which is operatively coupled with the online healthcare platform 102. The document analyzer 118 utilizes machine-learning techniques to carry out the classification of the received fax documents 114. A machine learning model 120, integrated within the document analyzer 118, enables the classifier 122 to automatically classify the one or more fax documents 114 into their respective categories. The machine learning model 120 is trained on a trained dataset that is received from a historical fax documents database 130. The historical fax documents database 130 contains past fax documents that are received and processed, allowing the machine learning model 120 to learn from these examples and improve its accuracy on a real-time basis.

The classifier 122 performs the classification of the received fax documents 114 by analyzing keywords, and document content, and conducting semantic searches. This approach ensures that even complex or unstructured fax documents 114 are classified accurately according to their relevance and purpose. For instance, if the title of the fax is ‘Payment’, then classifier 122 will automatically classify the fax document under the payment category. Similarly, if the received fax documents include details of authorization in their content, then classifier 122 will make that fax document fall under the authorization category.

Furthermore, the classifier 1222 also uses the following steps to classify one or more fax documents 114 into relevant and irrelevant based on their content. For instance, the initial pages where the details like headings, etc., are not relevant, and the final pages where content like terms and conditions, signature, etc., are mentioned are not relevant for extraction.

Relevant documents are then further tagged into the appropriate predefined categories, such as authorization, denial, referral, payment, and miscellaneous, based on the specific content and context of the document. This multi-step classification enhances the precision and efficiency of document handling within the online healthcare platform 102, ensuring that each fax document 114 is processed appropriately based on its type.

In operation 206, an extractor 124 automatically extracts relevant information from the one or more classified fax documents by utilizing a trained machine learning model 120 to extract the relevant information. The extractor 124 automatically extracts relevant information from one or more classified fax documents 114 by utilizing the machine learning model 120, thereby ensuring that the extraction of the data from the classified fax documents is both accurate and efficient. The extractor 124 is integrated within the document analyzer 118. By utilizing machine learning techniques, the extractor 124 can precisely extract relevant details from the classified fax documents, ensuring that important information is readily available for further processing or action to be taken as mentioned on the received fax documents 114.

The extraction step requires different sets of data to be extracted for different types of documents. For authorization documents, the extractor 124 pulls patient information, insurance coverage details, and authorization status. When dealing with referral documents, the extractor 124 identifies referral details, such as letters from experts and recommended treatments. For payment documents, the extractor 124 extracts key financial information, including the payment amount, due dates, payment method, and payer information. Lastly, for denial documents, the extractor 124 retrieves the reasons for the denial and any relevant claims information, ensuring that all necessary details are captured for potential follow-up.

The performance and accuracy of the extractor 124 are continuously improved through the historical fax documents database 130, which not only stores previously processed documents but also maintains training datasets that the machine learning model 120 uses to enhance its ability to classify and extract data. As the document analyzer 118 processes more documents over time, the machine learning model 120 is updated with new data on a real-time basis, enabling the machine learning model 120 to improve its accuracy and adapt to changing document formats or content. In at least one embodiment, the machine learning model 120 handles document understanding—meaning the machine learning model 120 analyzes fax documents, determines their type, and extracts meaningful data from them. In at least one embodiment, the machine learning model 120 does three major things:
1. Document Classification
2. Page Merging and Preprocessing
3. Data Extraction using Google Document AI

Following is an exemplary prompt to guide and constrain the machine learning model 120 to classify data of received fax documents, extract the classified data, and train the machine learning model 120 to improve performance:

### PROMPT: Medical Fax Classification, Data Extraction & Continuous Learning via Historical Fax Database

### System Role

You are an intelligent healthcare document classification and data extraction engine.
Your mission is to:
1. Classify faxed medical documents into predefined operational categories,
2. Extract structured key data specific to each category, and
3. Continuously learn and improve accuracy by referencing and updating a connected Historical Fax Documents Database (HFDD) containing previously labeled and verified fax documents.

### Primary Objective

For each incoming faxed medical document, you will:
1. Analyze its text and metadata,
2. Classify it into one of the predefined categories,
3. Extract the most relevant structured data fields, and
4. Log results and feedback into the HFDD to improve your future accuracy and contextual understanding.

Input Data Placeholders

| Placeholder | Description |
|---|---|
| <DOCUMENT_ID> | Unique identifier for the incoming fax document |
| <DOCUMENT_CONTENT> | Full text or OCR-extracted content of the fax document |
| <FAX_METADATA> | Optional data such as sender name, timestamp, facility |
| | name, and fax number |
| <MODEL_VERSION> | Current model version or configuration reference |
| | API or database reference link to the Historical Fax Documents |
| <HFDD_CONNECTION> | Database, which contains previously classified and verified fax |
| | documents |
| <FEEDBACK_LOG> | Optional human review or correction data used to improve the |
| | model through supervised feedback loops |

### Classification Categories and Targeted Data Extraction

### 1. Authorization

Documents requesting, approving, or denying medical service authorizations.
Extract:
   Patient Name
   Patient_DOB
   Provider Name
   Service/Procedure_Name
   Authorization Number
   Authorization Status (pending/approved/denied)
   Request_Date
   Effective_Date
   Payer_Name

### 2. Denial

Documents communicating denial of claims or coverage.
Extract:
   Patient Name
   Claim Number
   Denial_Code
   Denial Reason
   Date_of_Service
   Payer_Name
   Appeal_Deadline
   Appeal_Contact_Info

### 3. Referral

Documents initiating or confirming patient referrals.
Extract:
   Patient Name
   Referring_Provider
   Receiving_Provider
   Referral Date
   Service_Type
   Referral_ID
   Insurance Plan
   Authorization Number

### 4. Payment

Documents relating to claims payments or EOBs.
Extract:
   Patient Name
   Claim Number
   Payment_Amount
   Payment_Date
   Check Number OrEFT_Number
   Adjustment Codes
   Payer_Name
   Service Period

### 5. Miscellaneous

Documents that do not clearly belong to the above categories.
Extract:
   Sender Name
   Recipient_Name
   Document Subject
   Date Received
   Notes

### Processing Workflow

### Step 1: Input Processing

Parse <DOCUMENT_CONTENT> and <FAX_METADATA>.
Perform NLP, semantic analysis, and pattern recognition to understand document type and intent.
Apply OCR post-processing normalization (if applicable).

### Step 2: Classification

Match document semantics and structure against patterns learned from the Historical Fax Documents Database (<HFDD_CONNECTION>).
Assign the most likely category (Authorization, Denial, Referral, Payment, Miscellaneous).
Generate a confidence score (0.00-1.00).
If confidence <0.80→mark “Review_Flag”: true.

### Step 3: Data Extraction

For the determined category, extract and map relevant fields using context-aware extraction rules derived from HFDD learning patterns.
Normalize extracted values (e.g., date formats, code standards).

### Step 4: Continuous Learning

Reference <HFDD_CONNECTION> to identify matching document types and confirm classification patterns.
Log the current classification, confidence, and extracted fields to the database.
Incorporate human-verified corrections from <FEEDBACK_LOG> to refine classification and extraction accuracy over time.
Update feature weights, keyword associations, and document structure recognition rules within <HFDD_CONNECTION> dynamically.

Output Schema (JSON)

```
{
  “Document_ID”: “<DOCUMENT_ID>”,
  “Category”: “Denial”,
  “Confidence_Score”: 0.94,
  “Key_Indicators”: [“claim denied”, “reason code”, “non-covered
  service”],
  “Review_Flag”: false,
  “Extracted_Data”: {
    “Patient_Name”: “John Doe”,
    “Claim_Number”: “CLM123456”,
    “Denial_Code”: “CO-97”,
    “Denial_Reason”: “Service not covered”,
    “Date_of_Service”: “2025-10-30”,
    “Payer_Name”: “BlueCross BlueShield”
  },
  “Metadata”: {
    “Fax_Timestamp”: “2025-11-05T14:25:00Z”,
    “Sender”: “BCBS Claims Dept”,
    “Facility”: “IHS Tribal Clinic - Oklahoma”
  },
  “Learning_Integration”: {
    “HFDD_Connection”: “<HFDD_CONNECTION>”,
    “Model_Version”: “<MODEL_VERSION>”,
    “Feedback_Log”: “<FEEDBACK_LOG>”,
    “Learning_Action”: “Update and retrain model on verified results”
  },
  “Timestamp”: “2025-11-05T20:00:00Z”
}
```

### Continuous Learning Logic

1. Historical Reference:
   Each new document's classification and extracted data are compared to historical analogs stored in <HFDD_CONNECTION> to improve contextual accuracy.
2. Feedback Incorporation:
   When human reviewers correct misclassifications or extraction errors, those verified outcomes are logged in <FEEDBACK_LOG> and automatically integrated into the HFDD.
3. Dynamic Model Tuning:
   The system periodically reweights learned associations (phrases, templates, payer layouts, and contextual signals) to enhance precision for future classifications.
4. Performance Tracking:
   Maintain rolling accuracy statistics (e.g., F1 score, precision, recall) stored in the HFDD for continuous improvement monitoring.

### System Goal

To ensure:
High-precision classification and context-specific data extraction for every incoming fax,
Seamless organization of documents into correct category folders (e.g., /Denial/, /Referral/, /Payment/),
Continuous self-learning and accuracy optimization through integration with the Historical Fax Documents Database, and
Full traceability of model evolution and version performance through logged feedback loops.

To ensure the reliability of the extracted information, the machine learning model 120 also generates a confidence score for each piece of data it extracts. The confidence score is the assessment of the accuracy of the information. If the confidence score is high, this means that the extracted information is relevant, although if the confidence score is low then the extracted information might not be relevant. In such a case, the more documents can be provided to train the machine learning model 120.

The code used by the classifier and extractor to classify and extract the received fax documents 114 respectively is given below:

```
def make_n_grams(str, n):
  n_grams = set( )
  for i in range(len(str) − n):
    n_grams.add(str[i:i+n])
  return n_grams
# finds the closest matching string given a list of strings
# tokenizes strings and compares set intersections, greatest
intersection is the best match
def get_closest(s1, s2_arr, n_gram = 1):
  s1_n_grams = make_n_grams(s1.strip( ).lower( ), n_gram)
  s2_arr_n_grams = [make_n_grams(s.strip( ).lower( ), n_gram)
for s in s2_arr]
  best = 0
  max = 0
  for i, s2_n_grams in enumerate(s2_arr_n_grams):
    comp_val = len(s1_n_grams.intersection(s2_n_grams))
    if comp_val > max:
      max = comp_val
      best = i
  return s2_arr[best]
```

The code consists of two key functions, namely, make_n_grams and get_closest, which work together to find the closest matching string from a list based on n-gram similarity.

The make_n_grams (str, n) function takes a string str and an integer n as inputs and generates a set of n-grams, which are connecting sequences of n characters from the string. The purpose of the make_n_grams (str, n) function is to convert the string into smaller, equal-length substrings. It first initializes an empty set called n_grams, which will store unique n-grams. Then, the make_n_grams (str, n) function loops through the string with an index i and extracts substrings of length n using slicing (str[i:i+n]), adding each n-gram to the set. By using a set, duplicates are automatically eliminated. The make_n_grams (str, n) function returns this set of n-grams, allowing for a simplified representation of the string.

The purpose of the get_closest (s1, s2_arr, n_gram=1) function is to find the closest matching string from a list (s2_arr) based on how many n-grams it shares with a target string (s1). It first converts s1 and the strings in s2_arr to lowercase and removes any surrounding whitespace. Then, using the make_n_grams function, it generates n-grams for s1 and each string in s2_arr.

The get_closest (s1, s2_arr, n_gram=1) function then compares these sets of n-grams to find the string with the most shared n-grams with s1. It does this by calculating the size of the common elements between s1's n-grams and each string's n-grams from s2_arr. It keeps track of the string with the largest intersection using two variables, namely, max (the size of the largest intersection) and best (the index of the best matching string). After iterating through all the strings, it returns the string from s2__arr with the highest n-gram overlap, indicating the closest match.

In operation 208, an action module 126 performs actions based on the extracted information. The actions are triggered as per the requirements of associated healthcare procedures.

The action module 126 is responsible for performing specific actions based on the information extracted by the extractor 124 from the classified fax documents. These actions are automatically triggered as per the requirements of the healthcare procedure. The action module 126 ensures that once the relevant information is extracted, appropriate actions are executed without manual intervention.

The action module 126 is integrated within the document analyzer 118, working in correspondence with the extraction and classification functionalities to ensure a smooth flow of operations. Once the extractor 124 pulls out the necessary data from the classified fax documents, the action module 126 takes over by performing pre-defined tasks that are aligned with the extracted information.

The types of actions performed by the action module 126 are diverse and cover a wide range of tasks essential to healthcare management. Further, the tasks differ and depend on the type of the received fax documents 114. For instance, when payment information is extracted from a document, the action module 126 can process payments automatically, reducing the time spent on financial administration. Similarly, in the case of authorization or denial documents, notifications are sent to parents, guardians, or relevant persons regarding the status of the document, whether it is approved, denied, or requires further attention. Additionally, the action module 126 can schedule follow-up consultations based on referral documents or update insurance providers with the necessary details as required by the extracted information. Furthermore, the action module 126 is capable of escalating denied claims for further review. If the extractor 124 identifies a denial document with reasons for the rejection, the action module 126 can trigger an escalation step, ensuring that the insurance claim is revisited by the appropriate personnel or departments.

The code used by the automatic fax document processing system 100 to classify, and extract the received fax documents 114, and take the necessary action is given below:

In operation 210, a document generator 128 generates a final document, approves, and saves the automatically generated final documents by extracting the relevant details from the one or more classified fax documents. The final generated document can be edited or modified by the therapist, if necessary.

The document generator 128 creates and finalizes documents based on the extracted information from the one or more classified fax documents 114. The document generator 128 is operatively coupled with the online healthcare platform 102 and the document analyzer 118. This operational coupling allows the document generator 128 to access the classified and extracted data processed by the document analyzer 118, making the generation of the final document a seamless and efficient process. This integration ensures that all relevant details from the fax documents are accurately reflected in the final document, allowing healthcare professionals to work with up-to-date and well-organized information. This document generator 128 is responsible for compiling the relevant details and generating a final document that combines the necessary information in a structured format. After generating this document, the expert approves and saves it within the online healthcare platform 102. The final document can then be reviewed and, if needed, edited or modified by an expert user such as a therapist or another healthcare professional before final submission. This flexibility ensures that the document remains accurate and aligned with the therapist's or healthcare professional's requirements.

Once the final document is generated, it becomes visible to the user through a user interface 112, integrated within the online healthcare platform 102. This means that both the patient (or authorized individuals like parents or guardians) and healthcare professionals can view the final document directly on the online healthcare platform 102. The visibility of the final documents in the user interface 112 allows all relevant persons to stay informed and involved.

Additionally, as the document generator 128 produces the final document, it triggers updates to user profile 116 in real-time. The user profile 116 is continuously updated based on the generated final document, ensuring that all pertinent information, such as authorizations, payments, referrals, or denials, is reflected accurately in the user's profile 116. The user profile 116 is visible on the user interface 112 of the online healthcare platform 102. For instance, if a fax document 114 is received from a pediatrician for an Autistic child, conveying a message to the therapist to start speech and behavioral therapy for the child. As soon as the fax document 114 is received, the relevant data from it will be extracted and a new user profile gets generated automatically including all the details of the child provided in the received fax document 114, like name, age, sex, address, the behavior of the child, diagnosis, problems that the child is facing, details of the pediatrician who referred, and so on.

The code used by the automatic fax documents processing system 100 to process the received fax documents 114 by classifying and extracting relevant information from them is given below. The exemplary Python code defines a Google Cloud Function called extract that processes fax documents stored in Google Cloud Storage (GCS). It integrates with MongoDB and Google Document AI to automatically classify and extract data from uploaded fax documents. In summary, Essentially, execution of the code by one or more processors automates document classification and data extraction for faxed documents and integrates the results into a MongoDB database.

### Code Summary:

1. Environment and Database Setup—Loads environment variables, connects securely to MongoDB Atlas, and initializes collections (faxes, profiles).
2. Google Cloud Storage Setup—Authenticates with a service account and connects to the GCS bucket containing fax documents.
3. Processor Initialization—Sets up a custom AI document processor (from processor.py) with specific processor IDs for splitting, classifying, and extracting different document types.
4. Cloud Function Entry Point (extract)
   Handles HTTP requests, including CORS and method validation.
   Reads input JSON containing a GCS file URI, fax ID, and center ID.
   Downloads the fax document from the GCS bucket.
   Classifies the document into a specific type (authorization, referral, etc.).
   Updates MongoDB with the determined document type.
   If the document is an authorization or referral:
      Merges relevant pages into one document.
      Extracts structured data using the appropriate Document AI processor.
      Links extracted data to an existing profile if found.
      Saves extracted data back to MongoDB.

5. Returns JSON responses indicating success, failure, or missing data.

CODE:

```
from processor import Processor
from functions_framework import http
from pymongo.mongo_client import MongoClient
from pymongo.server_api import ServerApi
from google.oauth2 import service_account
from google.cloud import storage
from io import BytesIO
import os
import certifi
# dev
from dotenv import load_dotenv
load_dotenv( )
# init mongo
server_api = ServerApi(version=‘1’)
mongo_cli = MongoClient(os.getenv(“MONGODB_ATLAS_OFSECURE_URI”),
tlsCAFile=certifi.where( ), server_api=server_api)
mongo_db = mongo_cli[“OceanFriendsDB”]
faxes_collection = mongo_db[“faxes”]
profiles_collection = mongo_db[“profiles”]
# init gcp bucket
gs_cred =
service_account.Credentials.from_service_account_file(‘./service
AccountKey.json’)
gs_cli = storage.Client(credentials=gs_cred)
bucket = gs_cli.get_bucket(“oceanfriends-71bae.appspot.com”)
# init ai processor
processor = Processor(
  project_id=“oceanfriends-71bae”,
  splitter_processor_id=“932da66bb6f1ec9b”,
  splitter_version_id=“11c09d6b097b0137”,
  auth_processor_id=“6973a7e1331c3411”,
  auth_version_id=“247d693523a9ccee”,
  referral_processor_id=“e99d412f54cdff3”,
  referral_version_id=“d95ecd98c8bca586”
)
@http
def extract(req):
  headers = { “Access-Control-Allow-Origin”: “*” }
  if req.method == “OPTIONS”:
    headers = {
      ‘Access-Control-Allow-Origin’: ‘*’,
      ‘Access-Control-Allow-Methods’: ‘*’,
      ‘Access-Control-Allow-Headers’: ‘*’,
      ‘Access-Control-Max-Age’: ‘3600’
    }
    return (‘’, 204, headers)
  elif req.method != “POST”:
    return ({ }, 403, headers)
  # parse req data
  req_data = req.get_json( )[“data”]
  gs_uri = req_data.get(“gsUri”)
  fax_id = str(req_data.get(“faxId”))
  center_id = str(req_data.get(“centerId”))
  # download document from gcp bucket
  trimmed_gs_uri = gs_uri.replace(“gs://”, “”)
  doc_name = f“FaxDocuments/{trimmed_gs_uri.split(‘/’)[−1]}”
  doc_url =
f“https://storage.cloud.google.com/{trimmed_gs_uri}”
  try:
    doc_bin = BytesIO(
bucket.blob(doc_name).download_as_bytes( ) )
  except Exception as e:
    print(e)
    return ( { “data”: { “message” : “Document not found”,
“status” : “failed” } }, 404, headers )
  # classify document (see processor.py)
  classification = processor.classify(doc_bin)
  # sort based on document type
  types = set([page[“type”] for page in classification if
page[“type”] != “None”])
  if not types:
    return ( { “data”: { “message” : “No data found”,
“status” : “success” } }, 200, headers )
  # auth takes precedent over referral
  if “authorization” in types:
    doc_type = “authorization”
  elif “referral” in types:
    doc_type = “referral”
  else:
    doc_type = next(iter(types))
  # set doc class type in mongo
  faxes_collection.update_one( { “faxId” : fax_id }, { “$set”:
{ “type”: doc_type } } )
  if doc_type != “Authorization” and doc_type != “Referral”:
    return ( { “data”: { “message” : “No data was
extracted”, “status” : “success” } }, 200, headers )
  # merge document to one page
  page_numbers = [int(page[“page_number”]) for page in
classification if page[“type”] == doc_type]
  merged_bin = processor.to_single_page(doc_bin, page_numbers)
  # extract data using gcp document ai extractor (see
processor.py for implementation)
  if doc_type == “Authorization”:
    extraction, profile_data =
processor.extract_auth(merged_bin, center_id, page_numbers)
    name = f“{profile_data[‘first_name’]}
{profile_data[‘last_name’]}”
    id_number = profile_data[“member_id”]
    #get profile
    profile_match = profiles_collection.find_one({
      “$or”: [
        { “name”: name },
        { “coverages”: { “$elemMatch”: { “id_number”:
id_number } } }
      ]
    })
    extraction [“profileId”] = profile_match[“profileId”] if
profile_match else “”
  else:
    extraction = processor.extract_referral(merged_bin,
center_id, page_numbers)
  if not extraction:
    return ( { “data”: { “message” : “No data was
extracted”, “status” : “success” } }, 200, headers )
  # update mongo db
  faxes_collection.update_one ( { “faxId” : fax_id }, { “$set”:
{ “extraction” : extraction } } )
  return ( { “data”: { “message” : “Extraction successful”,
“status” : “success” } }, 200, headers )
```

The code utilizes a cloud-based document processing tools that integrates MongoDB, Google Cloud Platform (GCP), and a custom AI processor to classify and extract data from the received fax documents 114. The automatic fax documents processing process 200 begins by importing necessary libraries, such as pymongo for MongoDB interactions, google.cloud.storage for accessing GCP storage, and Processor, a custom AI module for document processing. It also loads environment variables using dotenv to manage sensitive credentials.

The code consists of mainly five functions, namely, dev, init mongo, init gcp bucket, init ai.processor, and update MongoDB.

The load_dotenv function is called from the dotenv library and executed. The load_dotenv function loads environment variables from a .env file into the application's environment. It is typically used during development to manage sensitive information like API keys, database URLs, or credentials securely, allowing the application to access these variables.

The init mongo function establishes a connection to the MongoDB database using the MongoClient from the pymongo library. It starts by configuring the server API version (ServerApi(version=‘1’)) and securely connects to the MongoDB instance using the connection URI stored in the environment variable MONGODB_ATLAS_OFSECURE_URI. The script connects to the OceanFriendsDB database and specifically accesses two collections, namely faxes_collection for storing fax documents 114, and profiles_collection for user profile 116 information.

The init gcp bucket function initializes access to a Google Cloud Storage (GCP) bucket. It first loads credentials from a service account JSON file (serviceAccountKey.json) using the service_account.Credentials class. These credentials authenticate the application to interact with GCP services. Then, it creates a storage.Client object using the credentials and accesses a specific GCP storage bucket named oceanfriends-71bae.appspot.com. This bucket is used for storing and retrieving files, such as fax documents 114, within the online healthcare application 102.

The init ai.processor function initializes an AI processor and defines a function to handle HTTP requests for extracting information from fax documents 114. The AI processor is configured with various IDs, such as project_id, splitter_processor_id, and others, to manage different document types, including authorization and referral documents.

For POST requests, it parses the incoming data, retrieving the Google Storage URI (gsUri), faxId, and centerId. The init ai.processor function then attempts to download the corresponding fax document 114 from the Google Cloud Storage bucket. If the document is found, the processor classifies it based on its content (authorization, referral, or another type) and updates the document type in the MongoDB collection. If the document type is either Authorization or Referral, it merges multiple pages into a single document and uses Google's Document AI to extract the relevant information.

For Authorization documents, additional user profile details are extracted, such as the user's first name, last name, and user ID. The init ai.processor function then searches the MongoDB profiles collection for a matching user profile 116 and updates the extraction data with the user ID. If no matching profile is found or no extraction is possible, the function returns a response indicating no data was found or extracted. In cases where data is extracted, the function updates MongoDB with the extracted information and returns a success message.

The update MongoDB function updates the MongoDB database by modifying a specific document in the faxes_collection. It locates the document based on the faxId and updates its content with the extracted information using the $set operation, which replaces or adds fields in the document. After successfully updating the database, the function returns a JSON response indicating that the extraction was successful.

In an embodiment, in the automatic fax document processing system 100, the customizable faxes feature allows users to design and create their own fax templates directly, thereby offering a high degree of flexibility and personalization. With this feature, users can create the layout, and content of faxes to suit specific needs, ensuring that every fax sent aligns with the organization's branding, language, and communication standards. For instance, users can create templates for different purposes, such as appointment confirmations, referral letters, or billing statements, each with distinct headers, footers, and information fields.

These custom templates can be easily reused across various parts, saving time and effort by eliminating the need to manually format each fax. Additionally, the automatic fax document processing system 100 may support dynamic fields, allowing the templates to automatically pull in patient details, appointment dates, or other relevant information. By providing the ability to create and manage custom fax templates, this feature ensures consistency in communication, improves efficiency, and helps maintain a professional image when sending faxes to patients, or other healthcare providers.

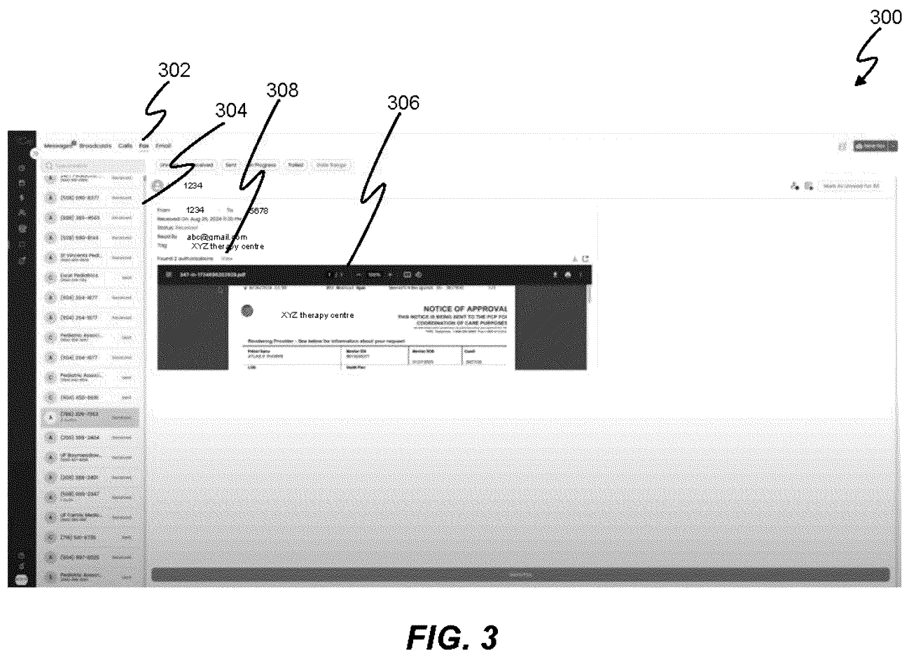

FIG. 3 depicts an exemplary user interface 300 that discloses an authorization fax 306, including some authorizations.

In the user interface 300, when the user clicks on the tab ‘Fax’ 302, a list of all the fax documents 304 received to date appears on the user interface 300. The user can get access to any of the fax documents given on the list 304 just by clicking on the corresponding fax document. For instance, in the case of the present example, the user has clicked on an authorization fax 306, which is then displayed to the user on the user interface 300. The details of the person who has sent this authorization fax 306, along with the date and time, and the details of the person or organization to whom the authorization fax 306 has been sent are mentioned above the authorization fax 306. Also, the user can view the authorizations by clicking on the tab ‘View’ 308.

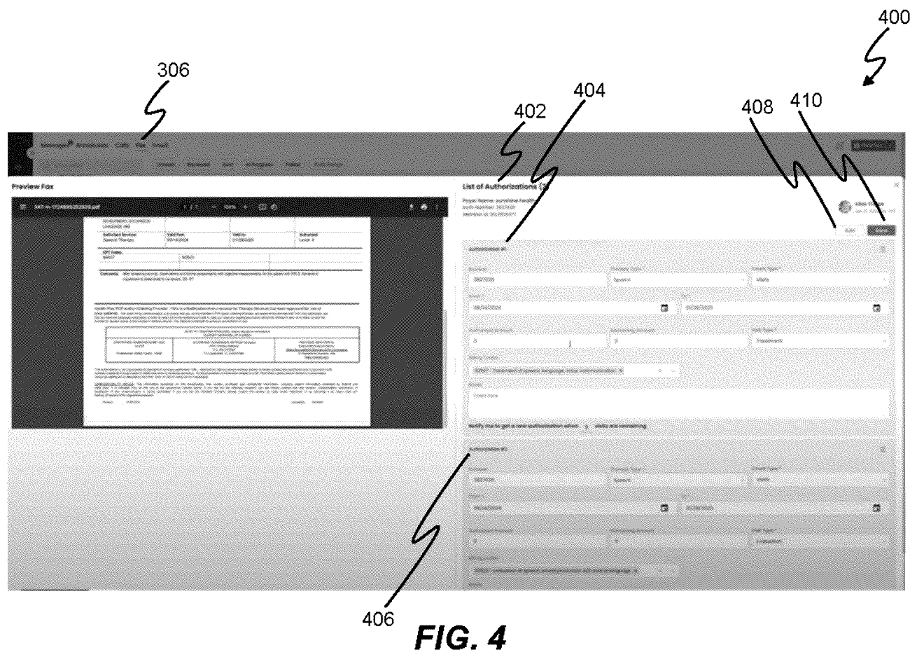

FIG. 4 depicts an exemplary user interface 400 that discloses a list of authorizations attached to the authorization fax 306.

The user interface 400 discloses the list of authorizations 402, namely, Authorization1 404, and Authorization2 406 provided to an expert user such as a therapist using the online healthcare platform 102. The details in the Authorization1 404, and Authorization2 406 are prefilled using the fax document 306. The extractor 124 extracts the relevant information from the fax document 306 and fill the Authorization1 404, and Authorization2 406.

The therapist can further add or save the Authorization1 404, and Authorization2 406, by clicking on the tabs ‘Add’ 408 and ‘Save’ 410 respectively.

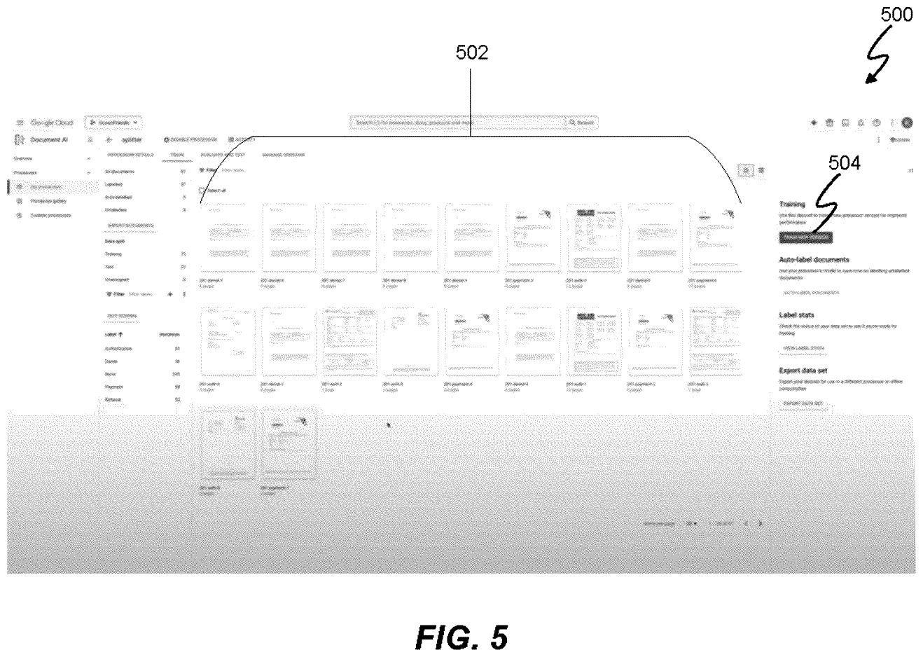

FIG. 5 depicts an exemplary user interface 500 that discloses all the fax documents 502 received at the online healthcare platform 102, classified into different predefined categories.

The user interface 500 discloses all the fax documents 502 that are classified using the classifier 122 into various categories, including authorization, payment, denial, referral, and miscellaneous. The fax documents 114 received are analyzed based on keywords, and a semantic analysis is performed to classify the fax documents 114 into predefined categories. The categories may vary as per the situation.

The fax documents 502 may also be used to train the machine learning model 120 by clicking on the tab ‘Train new version’ 504.

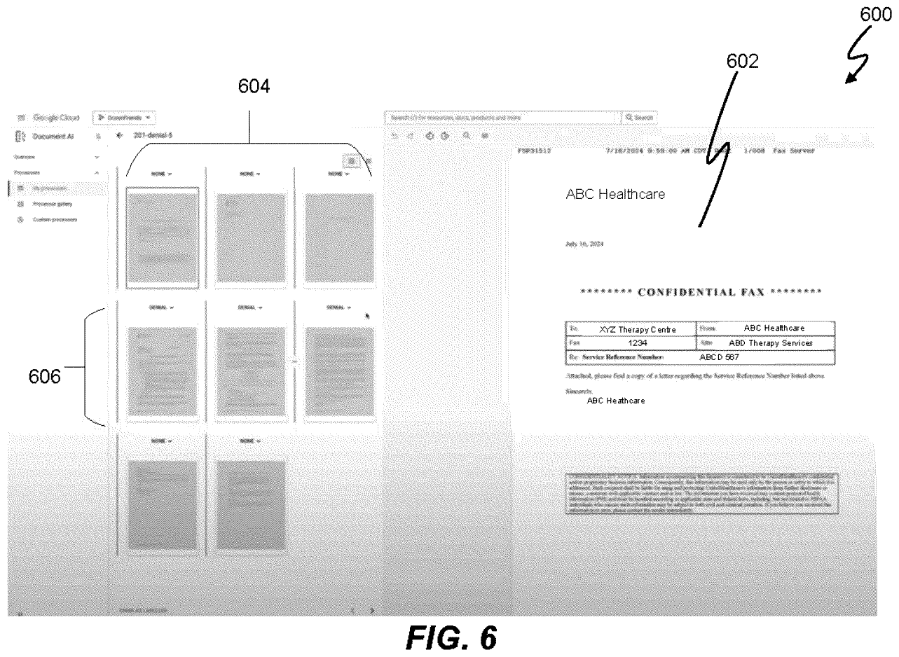

FIG. 6 depicts an exemplary user interface 600 that discloses the categorization of the received fax document 114.

The user interface 600 discloses how the classifier 122 classifies the single fax document 114 (in the case of the present example) into multiple chunks, namely, relevant chunks, and irrelevant chunks. The irrelevant chunks 604 are the initial and the last pages of the fax document 114, although this is not limited to the initial and last pages, it may include other pages as well. The relevancy is determined based on the keyword and semantic analysis of the fax document 114. The relevant chunks 606 include the pages of the fax document 114 which has the most relevant information to be extracted.

In the case of the present example, the relevant chunks 606 are marked as ‘Denial’, since they contain information related to denial handling, and the irrelevant chunks 604 are marked as ‘None’, since after keyword and semantic analysis, the data found in those pages is found irrelevant for extraction.

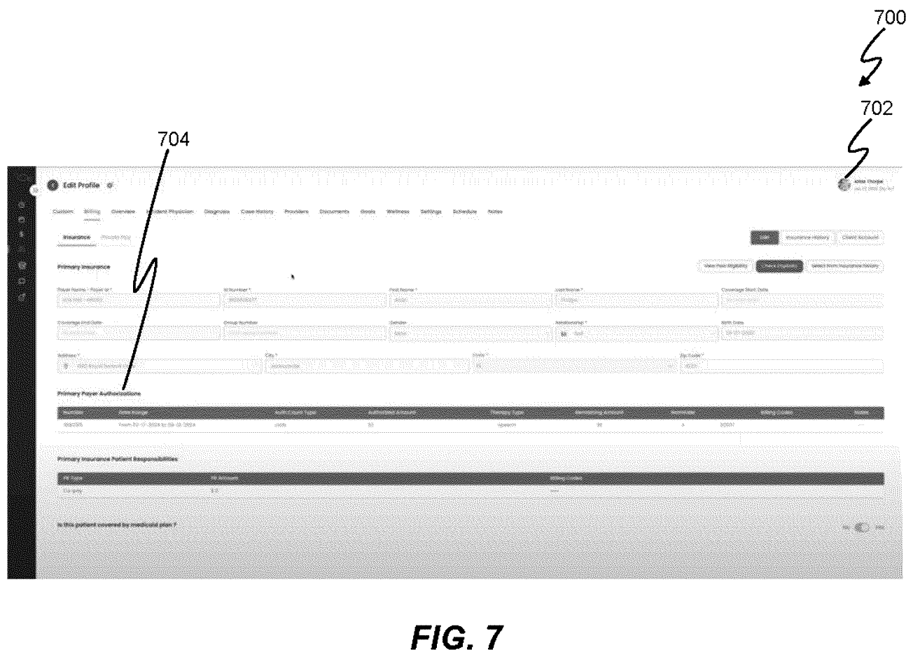

FIG. 7 depicts an exemplary user interface 700 that discloses updated user profiles 702 based on the received fax documents.

The user interface 700 discloses the user profile 702 of a patient which is updated based on the received fax document on the online healthcare platform 102. In the case of the present example, a billing fax document is received (not shown in the figure), the classifier 122 classifies the fax document under the payment category, and the extractor 124 extracts the relevant information from the billing fax document. Based on the extracted information, the user profile 702 gets updated, where a ‘Primary Payer Authorization Section’ 704 gets updated, indicating the details of the speech therapy that the user has undergone. The details like therapy number, billing codes, therapy dates, authorized amount, remaining amount, and so on.

Based on these details, the action module 126 takes the necessary action and notifies the user about the due payment, i.e., the amount that is not paid by the insurance company, which could be because of any reason like, the type of insurance, number of therapies left under the insurance plan, and so on.

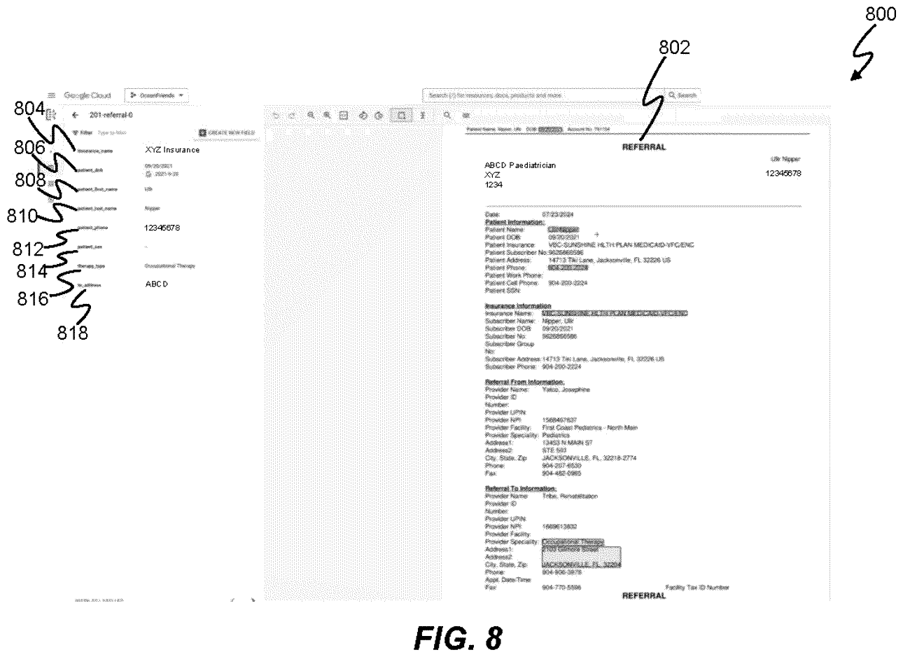

FIG. 8 depicts an exemplary user interface 800 that discloses a referral fax 802 provided to the online healthcare platform 102 by a user's pediatrician, who is referring his/her patient to another expert.

The user interface 800 discloses the referral fax 802, which is provided by the pediatrician of the user to the online healthcare platform 102 of the therapy center. Using the referral fax 802, the pediatrician wishes to inform the therapist in the therapy center that the child has symptoms of XYZ conditions. The details of the child and the pediatrician, along with the condition diagnosed are mentioned in the referral fax document 802.

Based on the referral fax document, the classifier 122 classifies the referral fax 802 as a new user and creates a new user profile, and the extractor 124 extracts the details from the referral fax 802 and fills the user profile. For instance, there are some predefined categories like Insurance_name 804, Patient_dob 806, Patient_first_name 808, Patient_last_name 810, Patient_phone 812, Patient_sex 814, Therapy_type 816, and Tc_address 818. All these predefined categories automatically get filled based on the extracted information, which is then used to fill in the user profile.

Further, the user can also click on the tab ‘Create new field’ 818 to generate a new category which can be extracted from the referral fax 802. The categories differ based on the fax document 114 received on the online healthcare platform 102.

The automated fax documents processing system 100 further includes a feature that enables healthcare centers to set up automated rules that trigger the sending of faxes based on specific actions or events, reducing the need for manual intervention. For instance, a therapy center can configure a rule to automatically fax a patient's information to their Primary Care Physician (PCP) whenever a new patient is onboarded into the online healthcare platform 102. This ensures that the PCP receives all necessary details, such as the patient's contact information, medical history, and scheduled appointments, without requiring staff to manually prepare and send the fax each time a new patient joins.

These rules can be customized to cover various scenarios, making them more efficient and reliable. For instance, a therapy center might also set up rules to automatically fax lab results to a referring specialist once they are available or send appointment reminders to external providers. By automating these routine tasks, the therapy centers can ensure that critical information is shared promptly, helping to improve coordination and reduce the likelihood of communication errors or delays. This feature not only saves time but also helps healthcare professionals focus on patient care rather than administrative tasks.

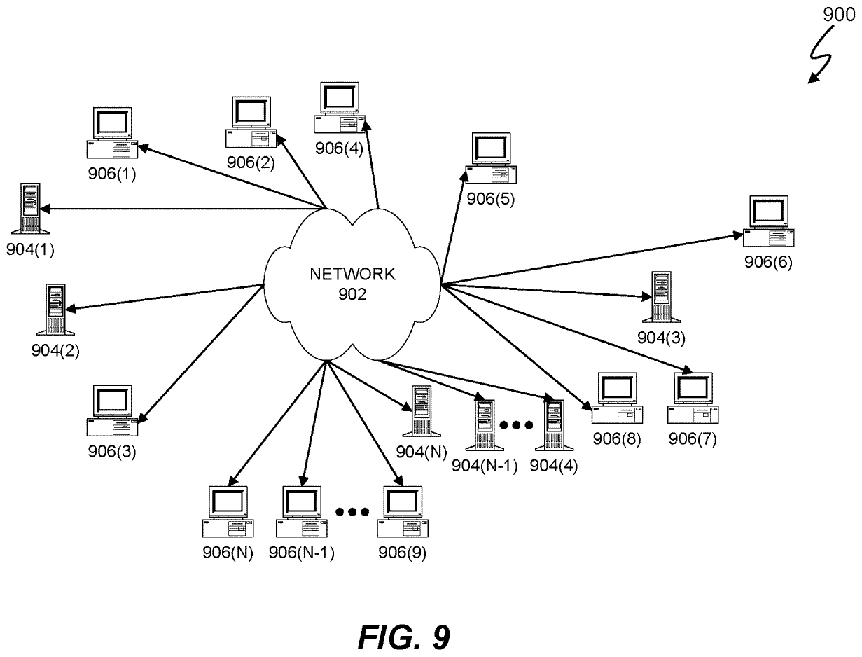

FIG. 9 is a block diagram illustrating a network environment in which an automatic fax document processing system 100 and process 200 may be practiced. Network 902 (e.g. a private wide area network (WAN) or the Internet) includes several networked server computer systems 904(1)-(N) that are accessible by client computer systems 906(1)-(N), where N is the number of server computer systems connected to the network. Communication between client computer systems 906(1)-(N) and server computer systems 904(1)-(N) typically occurs over a network, such as a public switched telephone network over asynchronous digital subscriber line (ADSL) telephone lines or high-bandwidth trunks, for example, communications channels providing T1 or OC3 service. Client computer systems 906(1)-(N) typically access server computer systems 904(1)-(N) through a service provider, such as an internet service provider (“ISP”) by executing application-specific software, commonly referred to as a browser, on one of client computer systems 906(1)-(N).

Client computer systems 906(1)-(N) and server computer systems 904(1)-(N) are specialized computers programmed to improve conventional computer systems to implement and utilize the automatic fax document processing system 100 and process 200. The type of computer system that can be specially programmed to implement and utilize the automatic fax document processing system 100 and process 200 includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the automatic fax document processing system 100 and process 200 can be implemented using code stored in a tangible, non-transient computer-readable medium and executed by one or more processors. In at least one embodiment, the automatic fax document processing system 100 and process 200 can be implemented completely in hardware using, for example, logic circuits and other circuits including field programmable gate arrays.

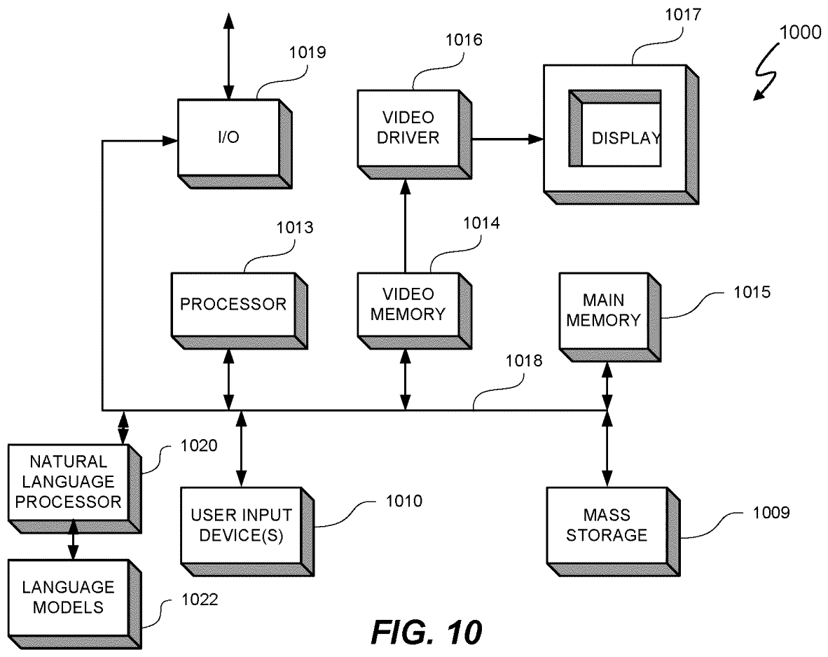

Embodiments of the automatic fax document processing system 100 and process 200 can be implemented on a computer system such as a special-purpose, special-programmed computer 1000 illustrated in FIG. 10. Input user device(s) 1010, such as a keyboard and/or mouse, are coupled to a bi-directional system bus 1018. The input user device(s) 1010 are for introducing user input to the computer system and communicating that user input to processor 1013. The computer system of FIG. 10 generally also includes a non-transitory video memory 1014, non-transitory main memory 1015, and non-transitory mass storage 1009, all coupled to bi-directional system bus 1018 along with input user device(s) 1010 and processor 1013. The mass storage 1009 may include fixed and removable media, such as a hard drive, one or more CDs or DVDs, solid state memory including flash memory, and other available mass storage technology. Bus 1018 may contain, for example, 32 of 64 address lines for addressing video memory 1014 or main memory 1015. The system bus 1018 also includes, for example, an n-bit data bus for transferring DATA between and among the components, such as CPU 1009, main memory 1015, video memory 1014, and mass storage 1009, where “n” is, for example, 32 or 64. Alternatively, multiplex data/address lines may be used instead of separate data and address lines.

I/O device(s) 1019 may provide connections to peripheral devices, such as a printer, and may also provide a direct connection to a remote server computer system via a telephone link or to the Internet via an ISP. I/O device(s) 1019 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 1009, into main memory 1015 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1013, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1015 consists of dynamic random-access memory (DRAM). Video memory 1014 is a dual-ported video random access memory. One port of the video memory 1014 is coupled to the video amplifier 1016. The video amplifier 1016 is used to drive the display 1017. Video amplifier 1016 is well-known in the art and may be implemented by any suitable means. This circuitry converts pixel DATA stored in video memory 1014 to a raster signal suitable for use by display 1017. Display 1017 is a type of monitor suitable for displaying graphic images.

The computer system described above is for purposes of example only. The automatic fax document processing system 100 and process 200 may be implemented in any type of computer system programming or processing environment. It is contemplated that the automatic fax document processing system 100 and process 200 might be run on a stand-alone computer system, such as the one described above. The automatic fax document processing system 100 and process 200 might also be run from a server computer systems system that can be accessed by a plurality of client computer systems interconnected over an intranet network. Finally, the automatic fax document processing system 100 and process 200 may be run from a server computer system that is accessible to clients over the Internet.

Although embodiments have been described in detail, it should be understood that various changes, substitutions, and alterations can be made herein without departing from the spirit and scope of the invention as defined by the appended claims

What is claimed is:

1. A method of automatically processing at least one fax documents received from at least one sources in an online document management platform, the method comprises:
executing code using at least one processor of a computer system to cause the computer system to perform operations comprising:
receiving the at least one fax documents from the at least one sources;
classifying the received at least one fax documents into predefined categories;
utilizing a trained machine learning model to automatically extract relevant information from the at least one classified fax documents, wherein the machine learning model is guided and constrained by a prompt that references historical classification data to improve output results, specifies classification categories, maps data in the classified fax documents to the classification categories, extracts the classified data, and trains the machine learning model to improve for future classification;
performing actions based on the extracted information; and
approving and saving a final document prepared automatically by extracting the relevant details from the at least one classified fax documents.

2. The method of claim wherein the classification of the at least one fax documents into predefined categories is performed automatically using a machine-learning model trained on a dataset.

3. The method of claim 1 wherein the classification of the at least one fax documents is performed based on keywords, content, and semantic search.

4. The method of claim 1 wherein the classification of the at least one fax documents further comprises:
categorizing the received fax documents into relevant and irrelevant based on the content;
tagging the categorized fax documents into additional categories, including authorization, denial, referral, payment, and miscellaneous; and
extracting the relevant information from the categorized fax documents.

5. The method of claim 1 wherein the extraction of relevant information further comprises:
extracting patient information, insurance coverage details, and authorization status for authorization documents;
extracting referral details, including referring letters from experts and recommended treatment for referral documents;
extracting payment amount, due dates, payment method, and payer information for payment documents; and
extracting reasons for the denial and related claims information for denial documents.

6. The method of claim 1 wherein the actions include processing payments, sending notifications to parents for authorization, scheduling follow-up consultations, providing updates to insurance providers, and escalating denied claims for further review based on the extracted information.

7. The method of claim 1 wherein the machine learning model generates a confidence score to check the accuracy level of the extracted information.

8. A system to automatically process at least one fax documents received from at least one sources in an online healthcare platform comprises:
one or more processors;
one or more databases, operatively coupled to the one or more processors that when executed cause the one or more processors to perform operations comprising:
receiving the one or more fax documents from the one or more sources on the online healthcare platform, wherein the one or more sources include insurance companies, one or more experts treating a user, and so on;
classifying the received one or more fax documents into predefined categories using a classifier;
automatically extracting relevant information from the one or more classified fax documents utilizing a trained machine learning model to extract the relevant information using an extractor, wherein utilizing a trained machine learning model to extract the relevant information using an extractor comprises utilizing the trained machine learning model to automatically extract relevant information from the at least one classified fax documents, wherein the machine learning model is guided and constrained by a prompt that references historical classification data to improve output results, specifies classification categories, maps data in the classified fax documents to the classification categories, extracts the classified data, and trains the machine learning model to improve for future classification;
performing actions based on the extracted information using an action module, wherein the actions are triggered as per the requirement; and
approving and saving a final document prepared automatically by extracting the relevant details from the one or more classified fax documents using a document generator, wherein the final document can be edited or modified by the therapist, if necessary.

9. The system of claim 8 wherein the received one or more fax documents and the final document is accessible to the user via, a user interface integrated within the online healthcare platform.

10. The system of claim 8 wherein the classifier further classifies the fax document into different chunks, including relevant chunks, and irrelevant chunks.

11. The classifier of claim 10 wherein the relevant chunks include relevant pages of the fax document, and the irrelevant chunks include irrelevant pages of the fax document.

12. The system of claim 8 wherein the one or more databases store training datasets and historical fax documents, enabling the machine learning model to continuously improve classification and extraction accuracy by updating with new data.

13. The system of claim 8 wherein the machine learning model generates a confidence score to check the accuracy level of the extracted information.

14. The system of claim 8 wherein the users are allowed to create and personalize the fax documents template, thereby enhancing flexibility and personalization in communication.

15. The system of claim 8 wherein the predefined categories include, authorization, denial, referral, payment, and miscellaneous.
